(19) United States
(12) Patent Application Publication
(10) Pub. No.: US 2005/0156963 A1
(43) Pub. Date: Jul. 21, 2005

(54) Ink-jet printing apparatus and head position adjustment method thereof

(76) Inventors: Se-kyong Song, Seoul (KR); Won Choe, Yongin-si (KR); Hyuk Kim, Seongnam-si (KR); Dong-eog Kim, Seoul (KR)

Correspondence Address: STANZIONE & KIM, LLP, 1740 N STREET, N.W., FIRST FLOOR, WASHINGTON, DC, 20036, US

(21) Appl. No.: 10/918,555

(22) Filed: Aug. 16, 2004

(30) Foreign Application Priority Data
Jan. 19, 2004 (KR) 2004-3737

(51) Int. Cl. B41J 29/38

(52) U.S. Cl. 347/9

(57) ABSTRACT

An ink-jet printing apparatus and a head position adjustment method which are capable of adjusting respective positions of multiple ink-jet heads in either a simultaneous manner or in an independent manner. The head position adjustment method can be applied to an ink-jet printing apparatus including a movable support table, a first ink-jet head fixedly coupled to the support table and provided with nozzles to eject ink, and a second ink-jet head arranged to be movable with respect to the first ink-jet head and provided with nozzles to eject ink. The head position method can include detecting respective positions of the first and second ink-jet heads, comparing the detected position of the first ink-jet head with a target position of the first ink-jet head, moving the support table to correct the position of the first ink-jet head, comparing the detected position of the second ink-jet head with a target position of the second ink-jet head if the detected position of the first ink-jet head is different from the target position of the first ink-jet head, and moving the second ink-jet head with respect to the first ink-jet head to correct the position of the second ink-jet head if the detected position of the second ink-jet head is different from the target position of the second ink-jet head.

### CROSS-REFERENCE TO RELATED APPLICATIONS

This application claims the benefit of Korean Patent Application No. 2004-3737, filed on Jan. 19, 2004 in the Korean Intellectual Property Office, the disclosure of which is incorporated herein by reference.

### BACKGROUND OF THE INVENTION

1. Field of the Invention

The general inventive concept of the invention relates to an ink-jet printing apparatus and a head position adjustment method thereof, and more particularly, to an ink-jet printing apparatus provided with a position adjusting device for ink-jet heads, and a head position adjustment method thereof.

2. Description of the Related Art

Generally, color filters are essentially used in display devices to make desired colors. Such color filters are mainly used in a liquid crystal display (LCD). Most display devices can only display monochromic images unless they are equipped with color filters. That is, such display devices can display desired colors, using color filters of three colors, that is, red (R), green (G), and blue (B). Each pixel of an LCD panel includes three dots, that is, R, G, and B dots. Here, “dots” mean respective domains where R, G and B colors are represented. The color of each pixel is determined in accordance with the amounts of light illuminated on respective dots of the pixel.

Meanwhile, an ink-jet printing apparatus is adapted to perform a printing operation by ejecting ink from a plurality of nozzles. Such an ink-jet printing apparatus is widely used because it generates reduced noise and enables color printing. The ink-jet printing apparatus includes a head as an essential element for ejecting ink to form an image on an object to be printed in accordance with a printing command. For ejection of ink, the head includes a plurality of nozzles.

Typically, such an ink-jet printing apparatus is used for manufacturing color filters. In order to accurately apply ink, discharged from an ink-jet head of the ink-jet printing apparatus, to cavities formed at a color filter for respective dots of each pixel, the nozzles of the ink-jet head are disposed at positions corresponding to the respective dots of the pixel, respectively. Where the position of each nozzle and the position of the associated dot do not correspond to each other, ink is applied to an incorrect position, thereby producing a poor-quality color filter. Therefore, the process of accurately aligning the nozzle and dot positions is important in terms of an improvement in the productivity of color filters.

Generally, a plurality of ink-jet heads are equipped in an ink-jet printing apparatus. An example of techniques for adjusting positions of such multiple ink-jet heads is disclosed in U.S. Pat. No. 6,565,206. However, the conventional ink-jet head position adjusting method disclosed in this patent only uses an angular position adjustment parameter for adjusting a rotation angle, that is, angular position, of an ink-jet head assembly including R, G, and B ink-jet heads, and a linear position adjustment parameter for adjusting a linear movement, that is, a linear position, of the ink-jet head assembly. For this reason, it is impossible to appropriately adjust relative distances of the ink-jet heads, and thus, to accurately adjust respective nozzle positions of each ink-jet head.

### SUMMARY OF THE INVENTION

In order to solve the above mentioned and/or other problems, it is an aspect of the present general inventive concept to provide an ink-jet printing apparatus and a head position adjustment method which are capable of adjusting respective positions of multiple ink-jet heads in either a simultaneous manner or in an independent manner.

Additional aspects and advantages of the present general inventive concept will be set forth in part in the description which follows and, in part, will be obvious from the description, or may be learned by practice of the invention.

The foregoing and/or other aspects of the present general inventive concept may be achieved by providing a head position adjustment method of an ink-jet printing apparatus including a movable support table, a first ink-jet head fixed to the support table and provided with nozzles to eject ink, and a second ink-jet head arranged to be movable with respect to the first ink-jet head and provided with nozzles to eject ink, the head position adjusting method including detecting respective positions of the first and second ink-jet heads, comparing the detected position of the first ink-jet head with a target position of the first ink-jet head, moving the support table to correct the position of the first ink-jet head if the detected position of the first ink-jet head is different from the target position of the first ink-jet head, and comparing the detected position of the second ink-jet head with a target position of the second ink-jet head, and moving the second ink-jet head with respect to the first ink-jet head to correct the position of the second ink-jet head if the detected position of the second ink-jet head is different from the target position of the second ink-jet head.

The foregoing and/or other aspects of the present general inventive concept may be achieved by providing an ink-jet printing apparatus including a movable support table, a driving unit to move the support table, a first ink-jet head fixedly coupled to the support table and provided with nozzles, a second ink-jet head arranged to be movable with respect to the first ink-jet head and provided with nozzles, and a position adjusting unit to move the second ink-jet head with respect to the first ink-jet head.

### BRIEF DESCRIPTION OF THE DRAWINGS

These and/or other aspects and advantages of the present general inventive concept will become more apparent and more readily appreciated from the following detailed description of the preferred embodiments taken in conjunction with the accompanying drawingsof which:

FIG. 1 is a perspective view illustrating an ink-jet printing apparatus according to an embodiment of the present general inventive concept;

FIG. 2 is a schematic view illustrating the ink-jet printing apparatus of FIG. 1;

FIG. 3 is a schematic view illustrating an operation of correcting a positional misalignment of a reference ink-jet head mounted on the ink-jet printing apparatus of FIG. 1;

FIG. 4 is a schematic view illustrating an operation of correcting positional misalignments of ink-jet heads, other than the reference ink-jet head, mounted on the ink-jet printing apparatus of FIG. 1; and

FIG. 5 is a flow chart illustrating a printing position adjusting operation of the ink-jet printing apparatus according to another embodiment of the present general inventive concept.

### DETAILED DESCRIPTION OF THE PREFERRED EMBODIMENTS

Reference will be made in detail to the embodiments of the general inventive concept, examples of which are illustrated in the accompanying drawings, wherein like reference numerals refer to like elements throughout. The embodiments are described below in order to explain the present general inventive concept by referring to the figures.

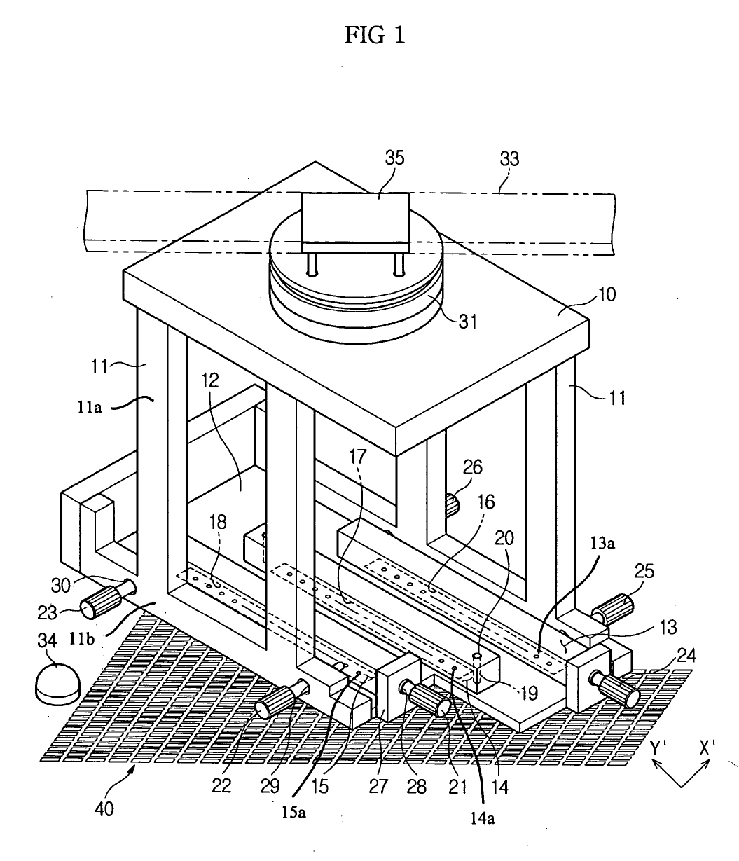

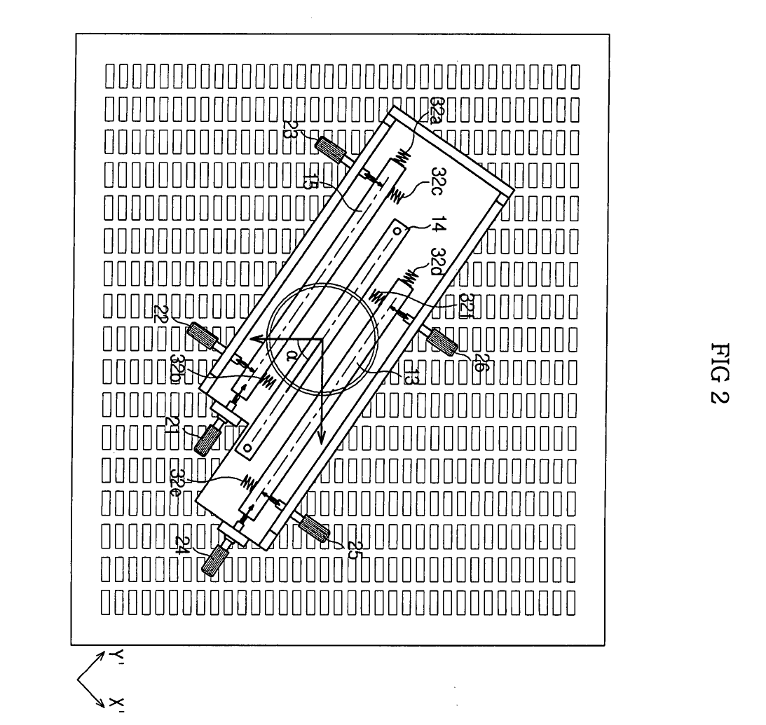

Referring to FIGS. 1 and 2, an ink-jet printing apparatus according to an embodiment of the present general inventive concept is illustrated. The ink-jet printing apparatus may include a motor mounting plate 10 to mount a rotating motor 31 thereon, and a head support table 12 to carry a plurality of ink-jet heads 13, 14 and 15 thereon. The motor mounting plate 10 can be connected to the head support table 12 by connecting members 11 to be integral with each other. Accordingly, when the rotating motor 31 operates, the motor mounting plate 10 can be rotated, that is, can move angularly, together with the rotating motor 31. The connecting members 11 can be mounted to opposite ends of the head support table 12, respectively. Each connecting member 11 may have vertical portions 11a connected to the motor mounting plate 10 at respective upper ends thereof, and a horizontal portion 11b mounted to the head support table 12 to connect lower ends of the vertical portions 11a.

The head support table 12 can be provided with head mounting slots 16, 17 and 18 to mount the ink-jet heads 13, 14 and 15 thereon, respectively. The ink-jet heads 13, 14 and 15 can be provided with a plurality of nozzles 13a, 14a, and 15a, respectively, at a lower portion thereof and can fit an associated one of the head mounting slots 16, 17 and 18.

In this embodiment of the present general inventive concept, the ink-jet printing apparatus can be provided with three ink-jet heads, that is, the ink-jet heads 13, 14 and 15, adapted to contain green (G) ink, red (R) ink, and blue (B) ink therein, respectively. However, the ink-jet printing apparatus may include an increased number of ink-jet heads. The ink-jet head 13, arranged at a rear portion of the head support table 12 as shown in FIG. 1, can be adapted to eject red ink (hereinafter, this ink-jet head is referred to as an “R ink-jet head”). The ink-jet head 15, arranged at a front portion of the head support table 12 as shown in FIG. 1, can be adapted to eject blue ink (hereinafter, this ink-jet head is referred to as a “B ink-jet head”). The ink-jet head 14, arranged at an intermediate portion of the head support table 12 as shown in FIG. 1, can be adapted to eject green ink (hereinafter, this ink-jet head is referred to as a “G ink-jet head”).

The G ink-jet head 14, arranged at the intermediate portion of the head support table 12, can serve as a reference for an angular movement. The G ink-jet head 14 can be fixedly coupled to the head support table 12, so that it moves angularly in accordance with an angular movement of the head support table 12. In order to fixedly couple the G ink-jet head 14 to the head support table 12, a fixing hole 19 can be formed at the G ink-jet head 14. In an assembly process for the G ink-jet head 14, a fixing pin 20, provided at the head supporting plate 12, can fit into the fixing hole 19 to fixedly couple the G ink-jet head 14 to the head support table 12.

However, the R and B ink-jet heads 13 and 15 may be installed such that they are movable (angularly and linearly movable) with respect to the G ink-jet head 14.

For such an installation of the R and B ink-jet heads 13 and 15, there can be provided first through fourth linear position adjusting members 21, 22, 24 and 25 each adapted to move an associated one of the R and B ink-jet heads 13 and 15 in an X′ or Y′-axis direction on the head supporting plate 12. There can also be provided first and second angular position adjusting members 23 and 26 each adapted to angularly move an associated one of the R and B ink-jet heads 13 and 15. A plurality of springs 32a, 32b, 32c, 32d, 32e and 32f are also provided. Each of the springs 32a, 32b, 32c, 32d, 32e and 32f can be mounted to an associated one of the R and B ink-jet heads 13 and 15 at an opposite side of an associated one of the first through fourth linear position adjusting members 21, 22, 24 and 25, and first and second angular position adjusting members 23 and 26, in order to control the associated R or B ink-jet head 13 or 15 to move toward the associated adjusting member 21, 22, 23, 24, 25 or 26.

The first linear position adjusting member 21 can be threadedly coupled to a first vertical plate 27 through a first linear position adjusting member coupling hole 28 formed on the first vertical plate 27 mounted to the head support table 12 while extending vertically. The first linear position adjusting member 21 can extend through the first linear position adjusting member coupling hole 28 such that an end thereof protrudes toward the B ink-jet head 15 to come into contact with a longitudinal end surface of the B ink-jet head 15 facing the first vertical plate 27, by virtue of the spring 32a. Female threads (not shown) can be formed on an inner surface of the first linear position adjusting member coupling hole 28, whereas male threads (not shown) can be formed on an outer surface of the first linear position adjusting member 21 to be threadedly coupled to the first vertical plate 27 through the first linear position adjusting member coupling hole 28. When the first linear position adjusting member 21 is rotated, it moves forward or backward in a longitudinal direction thereof. Thus, the first linear position adjusting member 21 can control the B ink-jet head 15 to linearly move in the Y′-axis direction. The second linear position adjusting member 22 can be threadedly coupled to the horizontal portion 11b of the connecting member 11 through a second linear position adjusting member coupling hole 29 formed on the horizontal portion 11b of the connecting member 11, which is disposed at a portion near a lateral surface of the B ink-jet head 15. The second linear position adjusting member 22 can extend through the second linear position adjusting member coupling hole 29 such that an end thereof protrudes toward the B ink-jet head 15 to come into contact with the lateral surface of the B ink-jet head 15 facing the horizontal portion 11b of the connecting member 11 using the spring 32b. Female threads (not shown) can be formed on an inner surface of the second linear position adjusting member coupling hole 29, whereas male threads (not shown) can be formed on an outer surface of the second linear position adjusting member 22 to be threadedly coupled to the second linear position adjusting member coupling hole 29. When the second linear position adjusting member 22 is rotated, it moves forward or backward in a longitudinal direction thereof. Thus, the second linear position adjusting member 22 can control the B ink-jet head 15 to linearly move in the X′-axis direction. At this time, the X′-axis movement of the B ink-jet head 15 can be carried out only at a portion of the B ink-jet head 15, with which the second linear position adjusting member 22 comes into contact, because an end of the B ink-jet head 15 is spaced away from the second linear position adjusting member 22 to be maintained in a fixed state by the first angular position adjusting member 23 and spring 32c.

The first angular position adjusting member 23 can be threadedly coupled to the horizontal portion 11b of the connecting member 11, arranged near the B ink-jet head 15, through a first angular position adjusting member coupling hole 30 formed at a position near the end of the B ink-jet head 15 opposite to the first vertical plate 27. The first angular position adjusting member 23 can extend through the first angular position adjusting member coupling hole 30 such that an end thereof protrudes toward the B ink-jet head 15 to come into contact with the lateral surface of the B ink-jet head 15 facing the lower end portion of the connecting member 11 using the spring 32c. Female threads (not shown) can be formed on an inner surface of the first angular position adjusting member coupling hole 30, whereas male threads (not shown) can be formed on an outer surface of the first angular position adjusting member 23 to be threadedly coupled to the horizontal portion 11b through the first angular position adjusting member coupling hole 30. When the first angular position adjusting member 23 is rotated, it moves forward or backward in a longitudinal direction thereof. Thus, the first angular position adjusting member 23 can control the B ink-jet head 15 to linearly move in the X′-axis direction. At this time, the X′-axis movement of the B ink-jet head 15 can be carried out by the first angular position adjusting member 23 in the form of an angular movement with respect to an end of the B ink-jet head 15 spaced away from the first angular position adjusting member 23 because this head end is maintained in a fixed state by the first and second linear position adjusting members 21 and 22 and springs 32a and 32b.

Although the linear position adjustment and angular position adjustment for the ink-jet head have been described as being implemented by use of an adjustment method using threads, they may be implemented by use of other adjustment methods (using, for example, piezo actuators, motors, etc.).

The third and fourth linear position adjusting members 24 and 25 adapted to adjust the linear position of the R ink-jet head 13 can be installed and operated in the same manners as those of the first and second linear position adjusting members 21 and 22, respectively. Also, the second angular position adjusting member 26 adapted to adjust the angular position of the R ink-jet head 13 can be installed and operated in the same manner as that of the first angular position adjusting member 23.

As described above, the rotating motor 31 can be arranged on the motor mounting plate 10 to rotate the motor mounting plate 10 together with elements of the ink-jet printing apparatus connected to the motor mounting plate 10. The rotating motor 31 may have a rotating shaft fixedly mounted to a slider 35 adapted to move the ink-jet printing apparatus along a rail 33 horizontally installed at a top of the ink-jet printing apparatus. The rotating shaft of the rotating motor 31 can be arranged such that a phantom line extending from the rotating shaft may pass through a center of a nozzle line, along which the nozzles of the G ink-jet head 14 may be aligned. Accordingly, when the rotating motor 31 operates, the motor mounting plate 10, the connecting members 11, the head support table 12, and the ink-jet heads 13, 14 and 15 can be rotated about the center of the nozzle line of the G ink-jet head 14 because the slider 35 is fixed with respect to the rotation direction of the rotating motor 31.

A high-resolution camera 34 adapted to pick up an image of the nozzle positions of the ink-jet heads 13, 14 and 15 can be installed adjacent to a stage (not shown), on which an LCD panel is laid upon an application of ink thereto.

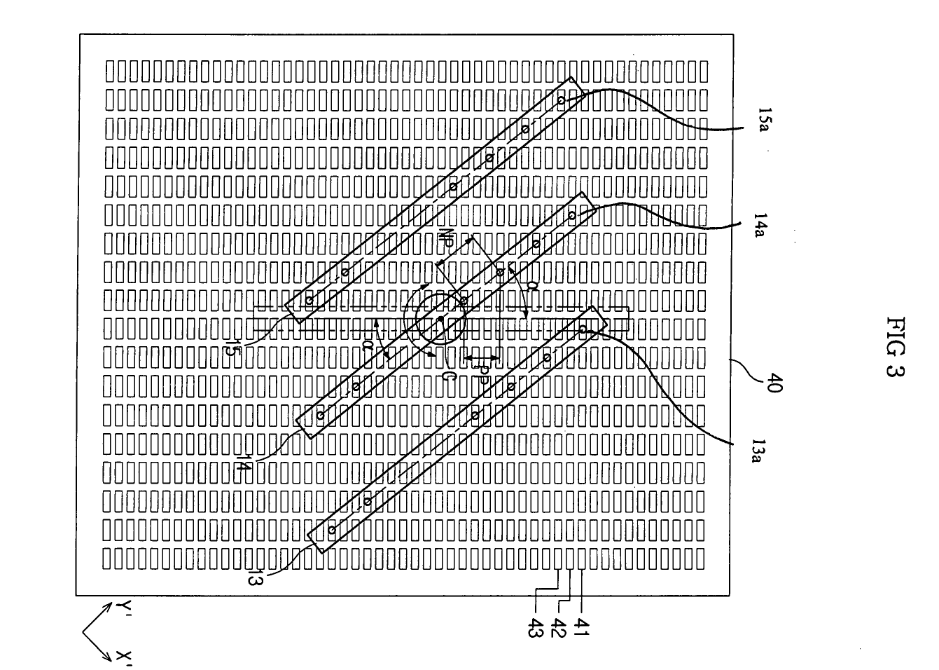

A position adjusting operation of the ink-jet printing apparatus according to the illustrated embodiment of the present general inventive concept will now be described with reference to FIGS. 3 to 5.

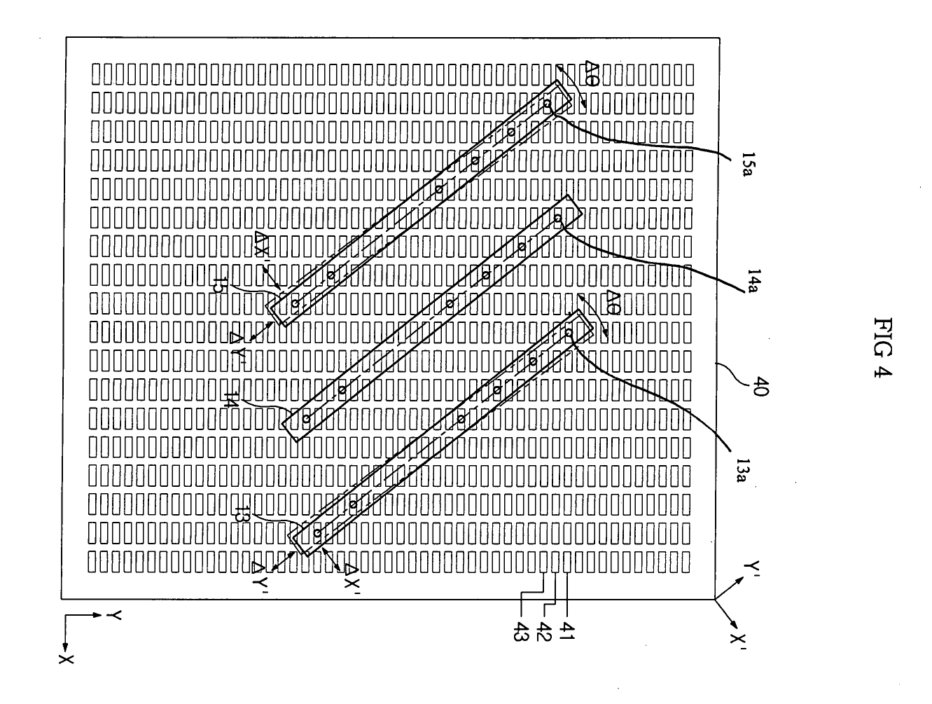

In FIGS. 3 and 4, a reference numeral 40 designates an LCD panel, a reference numeral 41 designates a row of red dots included in respective pixels of the LCD panel 40, a reference numeral 42 designates a row of green dots included in respective pixels of the LCD panel 40, and a reference numeral 43 designates a row of blue dots included in respective pixels of the LCD panel 40.

First, various information required to adjust respective positions of the ink-jet heads 13, 14 and 15 in the ink-jet printing apparatus can be inputted to a control unit (not shown). The information required to provide position adjustment may include a distance between adjacent ones of the nozzles included in respective ink-jet heads 13, 14, and 15, that is, a nozzle pitch of the nozzles of the ink-jet heads, a dot pitch of the LCD panel 40 (or a pitch of the red dot rows 41, a pitch of green dot rows 42, and a pitch of blue dot rows 43 in the LCD panel 40), information about a coordinate system to analyze an image picked up by the high-resolution camera 34, and information about a coordinate system set to drive the ink-jet heads 13, 14, and 15.

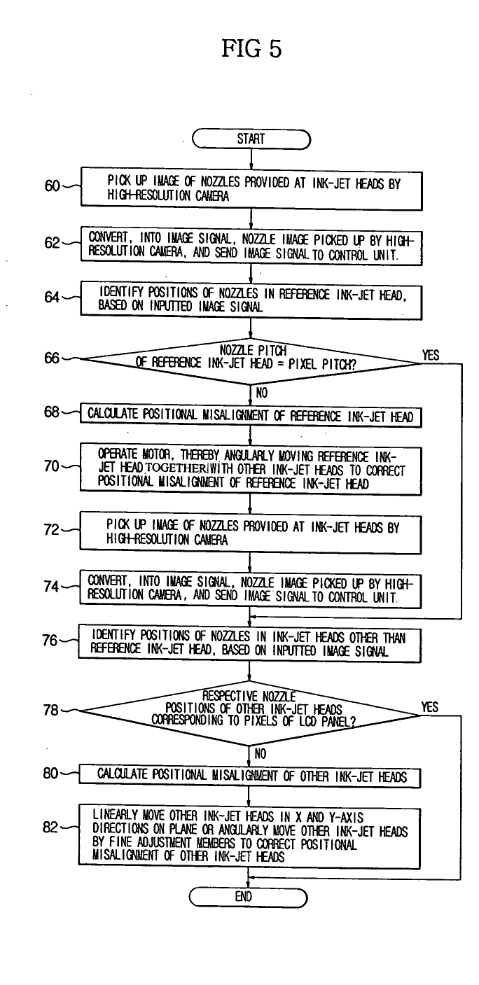

Thereafter, the control unit (not shown) can pick up an image of the nozzles included in the ink-jet heads 13, 14 and 15 by use of the high-resolution camera 34 in operation 60 in FIG. 5. The nozzle image picked up by the high-resolution camera 34 can be sent to the control unit after being converted into an image signal in operation 62. Using analysis information previously stored therein, the control unit can analyze the image signal sent from the high-resolution camera 34. Based on the analyzed image signal, the control unit can identify the positions of respective nozzles included in a reference one of the ink-jet heads 13, 14 and 15, including respective positions of first and final nozzles on a nozzle line of a reference ink-jet head in operation 64.

Here, the reference ink-jet head can be used as a reference for angular movements of the ink-jet heads 13 and 15 or linear movements of the ink-jet heads 13 and 15 in an X′ or Y′-axis direction on a plane to be carried out for adjustment of respective positions of the ink-jet heads 13 and 15. In this embodiment of the present general inventive concept, the G ink-jet head 14 can be set to the reference ink-jet head.

After the identification of the nozzle positions, it can be determined whether or not a nozzle pitch NP of the ink-jet heads 13 and 15 is equal to a pixel pitch PP of the LCD panel 40 in operation 66. The nozzle pitch NP means a distance between adjacent ones of the nozzles 13a, 14a, and 15a included in each ink-jet head, whereas the pixel pitch PP means a distance between adjacent ones of the dot rows ejecting ink of the same color. Where the nozzle pitch NP is equal to the pixel pitch PP, operation 76 is executed. On the other hand, where the nozzle pitch NP is different from the pixel pitch PP, the control unit can calculate an angular movement of the reference ink-jet head to to be performed to correct a positional misalignment caused by the pitch difference. In this case, the angular movement of the reference ink-jet head can be calculated with reference to the center C of the nozzle line of the reference ink-jet head.

Where the nozzle pitch NP is different from the pixel pitch PP, the nozzle positions of the reference ink-jet head 14 can be misaligned from the corresponding dot positions of the LCD panel 40 at an initial position of the reference ink-jet head 14. In order to align the nozzle positions with the corresponding dot positions, accordingly, the rotating motor 31 can be driven to control the reference ink-jet head 14 to move angularly by a desired angle α in operation 70. The angle α corresponds to “cos(Pixel Pitch/Nozzle Pitch),” that is, α=cos(PP/NP).

After the nozzles of the reference ink-jet head 14 are aligned with the corresponding dots of the LCD panel 40, that is, the green dots, in accordance with the angular movement of the reference ink-jet head 14, the control unit can pick up an image of the nozzles included in the ink-jet heads 13, 14 and 15 by use of the high-resolution camera 34 in operation 72. The nozzle image picked up by the high-resolution camera 34 can be sent to the control unit after being converted into an image signal in operation 74. Using the previously stored analysis information, the control unit can analyze the image signal sent from the high-resolution camera 34. Based on the analyzed image signal, the control unit can identify the positions of respective nozzles 13a and 15a included in the ink-jet heads 13 and 15 other than the reference ink-jet head 14, that is, the positions of the remaining ink-jet heads 13 and 15, including respective positions of the start and final nozzles on the nozzle lines of the ink-jet heads 13 and 15 in operation 76.

Although operations 72 to 76 have been described as being executed in accordance with the illustrated embodiment of the present general inventive concept, it may be possible to calculate the position of each ink-jet head and the position of each nozzle in each ink-jet head based on the initially picked-up nozzle image, while taking into consideration the angular movement of the reference ink-jet head without executing operations 72 to 76.

The control unit can then determine whether or not the identified nozzle positions of the remaining ink-jet heads 13 and 15 are aligned with corresponding target printing points of the LCD panel 40, that is, corresponding dot positions, respectively operation 78. That is, it can be determined whether or not respective positions of the nozzles in the R ink-jet head 13 are aligned with the positions of the corresponding red dots, and whether or not respective positions of the nozzles in the B ink-jet head 15 are aligned with the positions of the corresponding blue dots. Misalignment of respective nozzle positions from their corresponding dot positions is mainly caused by a fact that nozzle lines of the ink-jet heads are not parallel, so that it may be impossible to correct respective positional misalignments of the ink-jet heads only with the operation of angularly moving all ink-jet heads by the same angle.

Where the nozzle positions of the inkjet heads 13 and 15 are aligned with the corresponding dot positions, respectively, the control unit can complete the position adjusting operation. However, where the nozzle positions of the ink-jet heads 13 or 15 are misaligned from the corresponding dot positions, the control unit can calculate the positional misalignment.

That is, if respective nozzles of the R or B ink-jet head 13 or 15 are positioned to be misaligned from positions of corresponding red or blue dots, as shown in FIG. 4, it is necessary to correct the position of the associated R or B ink-jet head 13 or 15. In FIG. 4, “X” and “Y” represent respective axes of the coordinate system used for an image picked up by the camera 34, whereas “X′” and “Y′” represent respective axes of the coordinate system used for driving the ink-jet heads.

The third and fourth linear position adjusting members 24 and 25 can be used for a linear movement of the R ink-jet head 13, whereas the second angular position adjusting member 26 can be used for an angular movement of the R ink-jet head 13. Also, the first and second linear position adjusting members 21 and 22 can be used for a linear movement of the B ink-jet head 15, whereas the first angular position adjusting member 23 can be used for an angular movement of the B ink-jet head 15.

The correction of a positional misalignment of the ink-jet head 13 or 15 can be carried out by calculating the positional misalignment, based on a positional relation between the nozzle line of the ink-jet head 13 or 15 and the nozzle line of the position-corrected reference ink-jet head 14, and linearly or angularly moving the ink-jet head 13 or 15 using the calculated positional misalignment value. The positional misalignment of the nozzle line of the ink-jet head 13 or 15 from the nozzle line of the reference ink-jet head 14 can be calculated using the following expression:
Δx(Misalignment in X-axis Direction)=L*cos(α)+(L*sin(α)−PP/3)*tan(α)−x
Δy(Misalignment in Y-axis Direction)=PP/3−y [Expression]
where “L” represents a distance between the nozzle line of the reference ink-jet head and the nozzle line of the ink-jet head other than the reference ink-jet head, “α” represents a rotating angle of the reference ink-jet head, “PP” represents a pixel pitch, “x” and “y” represent a position of the start or final nozzle of the other ink-jet head measured with reference to the start or final nozzle of the reference ink-jet head on an X-Y plane or
Δx′(Misalignment in X′-axis Direction)=cos(α)Δx−sin(α)Δy
Δy′(Misalignment in Y′-axis Direction)=sin(α)Δx+cos(α)Δy
Δθ(Angular Misalignment)=cos(PP/NP)−tan((y1(s)−y1(f))/(x1(s)−x1(f)
where “PP” represents the pixel pitch, “NP” represents the nozzle pitch, “x1(s)” and “y1(s)” represent the position of the start nozzle on the nozzle line of the other ink-jet head measured with reference to the start nozzle of the reference ink-jet head on the X-Y plane, and “x1(f)” and “y1(f)” represent the position of the final nozzle on the nozzle line of the other ink-jet head measured with reference to the final nozzle of the reference ink-jet head on the X-Y plane.

Here, “Δx” and “Δy” represent the linear misalignment calculated on the X-Y plane, whereas “Δx” and “Δy′” represent the linear misalignment calculated on the X′-Y′ plane.

After the calculation of the linear and angular misalignments of the R and B ink-jet heads 13 and 15 based on the above expression, it is possible to correct the linear and angular misalignments by rotating the linear position adjusting members 21, 22, 24 and 25 and the angular position adjusting members 23 and 26 by the calculated linear and angular misalignment values. For example, where linear misalignments of “Δx′” and “Δy′” and an angular misalignment of “Δθ” are calculated for the B ink-jet head 15, the first linear position adjusting member 21 can be rotated to move the B ink-jet head 15 in the Y′-axis direction, thereby correcting the Y′-axis misalignment. Next, the second linear position adjusting member 22 can be rotated to move the B ink-jet head 15 in the X′-axis direction, thereby correcting the X′-axis misalignment. Finally, the first angular position adjusting member 23 can be rotated to angularly move the B ink-jet head 15 by a desired angle, thereby correcting the angular misalignment. In such a manner, the linear and angular misalignments of the R ink-jet head 15 can also be corrected.

In the above described embodiment of the present general inventive concept, the LCD panel has been illustrated as an object to be printed by the ink-jet printing apparatus of the present general inventive concept. However, matters other than the LCD panel, for example, paper, may be used as the object to be printed.

As apparent from the above description, in accordance with the present general inventive concept, it is possible to adjust respective positions of multiple ink-jet heads in either an independent manner or a simultaneous manner. It is also possible to accurately align respective nozzle positions of each ink-jet head with corresponding dot positions, using linear position adjusting parameters, which is not taken into consideration in conventional cases. In accordance with the present general inventive concept, it is possible to perform a printing process even when there is a variation in target printing position (for example, a variation in the pixel pitch of an LCD panel to be printed), because the printing position of the ink-jet printing apparatus can be adjusted without modification of the configuration of the ink-jet printing apparatus.

Although the preferred embodiments of the general inventive concept have been disclosed for illustrative purposes, those skilled in the art will appreciate that various modifications, additions and substitutions are possible, without departing from the scope and spirit of the invention as disclosed in the accompanying claims and equivalents thereof.

1. A head position adjustment method of an ink-jet printing apparatus including a movable support table, a first ink-jet head fixed to the support table, and provided with nozzles to eject ink, and a second ink-jet head arranged to be movable with respect to the first ink-jet head, and provided with nozzles to eject ink, the head position adjusting method comprising:
detecting respective positions of the first and second ink-jet heads;
comparing the detected position of the first ink-jet head with a target position of the first ink-jet head, and moving the support table to correct the position of the first ink-jet head if the detected position of the first inkjet head is different from the target position of the first ink-jet head; and
comparing the detected position of the second ink-jet head with a target position of the second ink-jet head, and moving the second ink-jet head with respect to the first ink-jet head to correct the position of the second ink-jet head if the detected position of the second ink-jet head is different from the target position of the second ink-jet head.

2. The head position adjustment method according to claim 1, wherein the correcting of the position of the first ink-jet head comprises:
calculating a misalignment between the target position of the first ink-jet head and a position of a selected one of the nozzles in the first ink-jet head corresponding to the target position of the first ink-jet head; and
angularly moving the support table to simultaneously angularly move the first and second ink-jet heads to correct the calculated misalignment of the first ink-jet head.

3. The head position adjustment method according to claim 2, wherein the misalignment corresponds to a misalignment between a current position of the first ink-jet head and a position of the first ink-jet head where a distance between adjacent ones of the nozzles in the first ink-jet head corresponds to a distance between target positions of the first ink-jet head respectively corresponding to the adjacent nozzles.

4. The head position adjustment method according to claim 2, wherein the first and second ink-jet heads are angularly movable about a point on a nozzle line, along which the nozzles of the first ink-jet head are aligned.

5. The head position adjustment method according to claim 1, further comprising:
re-detecting a position of the second ink-jet head to correct the position of the second ink-jet head.

6. The head position adjustment method according to claim 1, wherein the correcting of the position of the second ink-jet head comprises:
calculating a misalignment between the target position of the second ink-jet head and a position of a selected one of the nozzles in the second ink-jet head corresponding to the target position of the second ink-jet head; and
linearly or angularly moving the second ink-jet head with respect to the first ink-jet head to correct the calculated misalignment of the first ink-jet head.

7. The head position adjustment method according to claim 6, wherein the correction of the position of the second ink-jet head is carried out by performing the linear movement of the second ink-jet head and then performing the angular movement of the second ink-jet head.

8. The head position adjustment method according to claim 6, wherein the misalignment corresponds to a misalignment between a current position of the second ink-jet head and a position of the second ink-jet head where the position of the selected nozzle in the second ink-jet head is aligned with a position of a dot corresponding to the target position of the second ink-jet head.

9. The head position adjustment method according to claim 1, wherein the second ink-jet head is adapted to eject ink of a color different from that of the first ink-jet head.

10. An ink-jet printing apparatus comprising:
a movable support table;
a driving unit to move the support table;
a first ink-jet head fixedly coupled to the support table, and provided with nozzles;
a second ink-jet head arranged to be movable with respect to the first ink-jet head, and provided with nozzles; and
a position adjusting unit to move the second ink-jet head with respect to the first ink-jet head.

11. The ink-jet printing apparatus according to claim 10, wherein the position adjusting unit comprises:
linear position adjusting members to perform linear movements of the second ink-jet head in a longitudinal direction of the second ink-jet head and in a direction orthogonal to the longitudinal direction, respectively; and
an angular position adjusting member to perform an angular movement of the second ink-jet head.

12. The ink-jet printing apparatus according to claim 11, wherein the linear position adjusting members are arranged on an longitudinal end surface of the second ink-jet head and on a longitudinal surface of the second ink-jet head opposite to the first ink-jet head at one side of the second ink-jet head, respectively, and the angular position adjusting member is arranged on the longitudinal surface of the second ink-jet head at the other side of the second ink-jet head.

13. The ink-jet printing apparatus according to claim 10, wherein the second ink-jet head is adapted to eject ink of a color different from that of the first ink-jet head.

14. An ink-jet printing apparatus comprising:
a movable support table;
a first ink-jet head fixed fixedly coupled to the support table and having first nozzles;
a second ink-jet head movably coupled to the support table and having second nozzles;
a driving unit to control the support table to move in an angular direction thereof; and
a position adjusting unit to control the second ink-jet head to move in an angular direction and a linear direction with respect to the first ink-jet head so that the first nozzles are aligned with the second nozzles.

15. The printing apparatus according to claim 14, further comprising:
a third ink-jet head movably coupled to the support table and having third nozzles, wherein the position adjusting unit controls the third ink-jet head to move with respect to the support table.

16. The printing apparatus according to claim 15, wherein the first ink-jet head is disposed between the second and third ink-jet heads.

17. The printing apparatus according to claim 15, wherein the position adjusting unit controls the second ink-jet head and the third ink-jet head to move with respect to the first ink-jet head.

18. The printing apparatus according to claim 14, wherein the driving unit controls the first ink-jet head to rotate with respect to a rotating center of the movable support table.

19. The printing apparatus according to claim 14, wherein the driving unit controls the first and second ink-jet heads to rotate with respect to a rotating axis of the support table.

20. The printing apparatus according to claim 14, wherein the position adjusting unit controls the second ink-jet head to move in at least one of linear and angular directions with respect to the first ink-jet head.

21. The printing apparatus according to claim 14, wherein the position adjusting unit comprises a linear position adjusting member and an angular position adjusting member to control the second ink-jet head to move in a linear direction and an angular direction with respect to the first ink-jet head.

22. The printing apparatus according to claim 14, wherein the first nozzles are arranged in a first nozzle line, the second nozzles are arranged in a second nozzle line, and the second ink-jet head is controlled with respect to the first ink-jet head so that the first nozzle line is aligned with the second nozzle line.

23. The printing apparatus according to claim 14, further comprising:
a rail;
a slider slidably moving along the rail;
a motor mounting plate rotatable with respect to the slider according to a movement of the driving unit; and
a connecting element coupled to the motor mounting plate, wherein the support plate is fixedly coupled to the connecting element.

24. The printing apparatus according to claim 23, wherein the support plate comprises a first slot through which the first nozzles are exposed, and a second slot through which the second nozzles are exposed, and the second nozzles are movable with respect to the second slot according to a movement of the second ink-jet head with respect to the first ink-jet head.

25. An ink-jet printing apparatus comprising:
a movable support table;
an ink-jet head movably coupled to the support table, and having nozzles;
a driving unit to control the support table to move with respect to a rotating axis thereof; and
a position adjusting unit to control the ink-jet head to move in an angular direction and a linear direction.

26. A head position adjustment method for an ink-jet printing apparatus, the method comprising:
movably coupling an ink-jet head having nozzles to a movable support table;
controlling the support table to move with respect to a rotating axis of the support table; and
controlling the ink-jet head to move in an angular direction and a linear direction with respect to the support table.
